(19) United States
(12) Patent Application Publication
(10) Pub. No.: US 2025/0058467 A1
(43) Pub. Date: Feb. 20, 2025

(54) FAILURE PREDICTION DEVICE

(71) Applicant: FANUC CORPORATION, Minamitsuru-gun, Yamanashi (JP)

(72) Inventor: Shuxiao XIE, Yamanashi (JP)

(21) Appl. No.: 18/723,984

(22) PCT Filed: Jan. 25, 2022
(86) PCT No.: PCT/JP2022/002560

§ 371 Date: Jun. 25, 2024

(51) Int. Cl. B25J 9/16; B25J 19/00; G05B 23/02

(52) U.S. Cl. CPC B25J 9/1674; B25J 19/0095; G05B 23/0221

(57) ABSTRACT

The purpose of the present invention is to accurately predict failure of a robot without erroneous detection even if the pattern of operation of the robot changes. This failure prediction device is provided with: an evaluation data collection unit that collects evaluation data for at least a drive shaft of a robot working on the basis of a work program; and an erroneous detection determination unit that uses the evaluation data to derive an evaluation formula for evaluating the evaluation data, and determines whether the evaluation data is an evaluation data value attributed to a factor other than failure of the robot, or an evaluation data value attributed to a failure factor for the robot, on the basis of the evaluation formula and the evaluation data.

### TECHNICAL FIELD

The present invention relates to a failure prediction device.

### BACKGROUND ART

There is a desire for technology that can predict robot failures, i.e., detect signs of robot failure and notify a user before the robot can no longer operate properly. In general, it is known that, when a robot fails, the driving torque during operation increases. Therefore, it has been proposed to predict a failure by monitoring changes in driving torque or the like.

For example, Patent Document 1 discloses a technology for performing failure diagnosis based on a magnitude relationship between a measurement value of a sensor group such as a torque sensor, a temperature sensor, and an acceleration sensor, and a reference value.

Patent Document 2 discloses a technology of collecting torque values of the drive shaft of the robot operating in accordance with a given work program, deriving an evaluation equation for approximating the temporal change of the most recent torque value from the collected torque values, setting a failure threshold that is a torque value that is determined to be a failure of the drive shaft, based on the evaluation equation and the temporal change of the torque value when the drive shaft has failed in the past, calculating an estimated value of the torque value when a predicted time set in advance in the evaluation equation has elapsed, and determining whether a failure of the drive shaft is predicted within the predicted time by comparing the estimated value with the failure threshold.

### CITATION LIST

### Patent Document

Patent Document 1: Japanese Unexamined Patent Application, Publication No. 2006-285884
Patent Document 2: Japanese Unexamined Patent Application, Publication No. 2021-22074

### DISCLOSURE OF THE INVENTION

### Problems to be Solved by the Invention

The degree of increase of the driving torque until the robot fails and the driving torque at the time of occurrence of the failure vary depending on the operation pattern of the robot. Therefore, as disclosed in Patent Document 1, in a method of comparing a current measured value with a reference value, the robot may be determined to be close to failure even though it still has a long life expectancy.

Furthermore, in Patent Document 2, it is necessary to receive a signal for specifying a work program being executed or a signal for notifying a change of the work program from the robot control device, reset torque values collected for each change of the work program, and collect new torque values, which is time consuming.

Furthermore, there is a possibility that Patent Documents 1 and 2 may falsely detect a failure every time a non-failure element such as a change in the operation pattern of the robot due to a change in the work program changes.

Therefore, even if the operation pattern of the robot changes, it is desirable to accurately predict whether the evaluation data value detected due to the change of the operation pattern is an evaluation data value due to a factor causing a failure of the robot without falsely detecting the evaluation data value as a failure.

### Means for Solving the Problems

One aspect of a failure prediction device of the present disclosure includes an evaluation data collection unit configured to collect evaluation data of at least a drive shaft of a robot working based on a work program, and a false detection determination unit configured to derive an evaluation equation for evaluating the evaluation data using the evaluation data and to determine whether the evaluation data is an evaluation data value due to a factor other than a failure of the robot or an evaluation data value due to a factor causing a failure of the robot, based on the evaluation equation and the evaluation data.

One aspect of a failure prediction device of the present disclosure includes an evaluation data collection unit configured to collect evaluation data of a robot working based on a work program, a false detection determination unit configured to determine whether the evaluation data is an evaluation data value due to a factor other than a failure of the robot or an evaluation data value due to a factor causing a failure of the robot, and a display control unit configured to cause a display unit to display at least one of a prediction result of a failure of the robot predicted based on the evaluation data or information indicating a determination result of the false detection determination unit. When the evaluation data value due to the factor other than the failure of the robot is determined, the display control unit causes the display unit to preferentially display information indicating the evaluation data value due to the factor other than the failure of the robot.

### Effects of the Invention

According to one aspect, even if the operation pattern of a robot changes, it is possible to accurately predict whether the evaluation data value detected due to the change of the operation pattern is an evaluation data value due to a factor causing a failure of the robot without falsely detecting the evaluation data value as a failure.

### BRIEF DESCRIPTION OF THE DRAWINGS

FIG. 1 shows an example of the configuration of a robot system including a failure prediction device according to one embodiment;

FIG. 2 shows an example of an evaluation equation of a torque value;

FIG. 3 shows an example of a false detection evaluation equation of a torque value;

FIG. 4 shows an example of a false detection evaluation equation of a torque value;

FIG. 5 shows an example of display by a display control unit; and

FIG. 6 is a flowchart illustrating the failure prediction processing of the failure prediction device.

### PREFERRED MODE FOR CARRYING OUT THE INVENTION

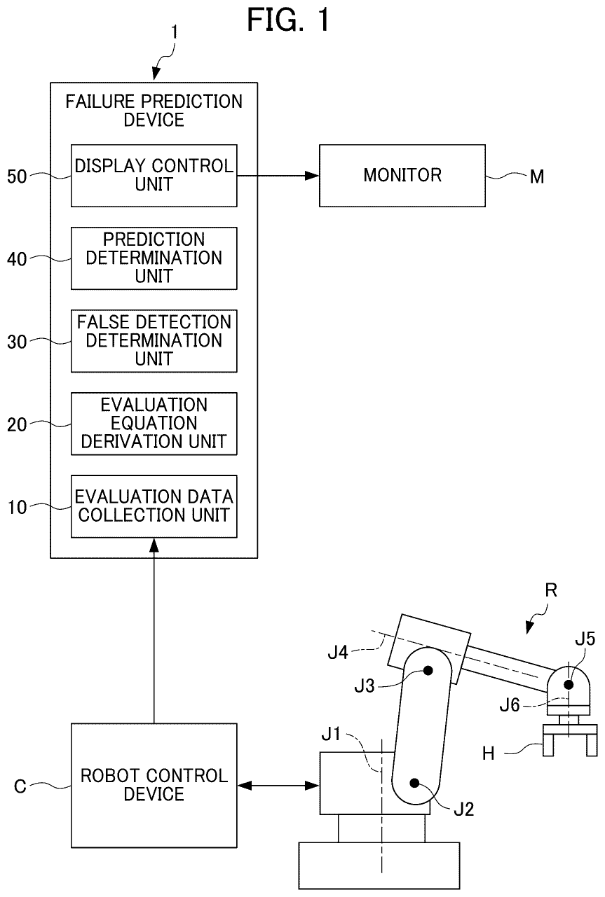

One embodiment will now be described with reference to the drawings. FIG. 1 shows an example of the configuration of a robot system including a failure prediction device 1 according to one embodiment.

The robot system includes a robot R, a robot control device C that controls the robot R, a failure prediction device 1 that communicates with the robot control device C, and a monitor M as a display unit whose display content is controlled by the failure prediction device 1.

The robot R, the robot control device C, the failure prediction device 1, and the monitor M may be directly connected to each other via a connection interface (not shown). The robot R, the robot control device C, the failure prediction device 1, and the monitor M may be connected to each other via a network (not shown) such as a LAN (local area network) or the Internet. In this case, the robot R, the robot control device C, the failure prediction device 1, and the monitor M are each provided with a communication unit (not shown) for communicating with each other through such a connection.

The robot R includes a plurality of drive shafts J1, J2, J3, J4, J5, and J6, and a hand H capable of holding a workpiece, for example, is provided at the leading end. The robot R can perform a desired operation by moving the hand H by driving the drive shafts J1 to J6. The robot R may be a vertical articulated robot as shown in the figure, but is not limited thereto, and may be, for example, an orthogonal coordinate robot, a scalar robot, a parallel link robot, or the like. The robot R includes a torque detection unit (not shown) that detects torque values (for example, torque, current value, or the like of a motor that drives the drive shaft) of the drive shafts J1 to J6.

The robot control device C operates the robot R in accordance with a given work program. Specifically, the robot control device C may have a well-known configuration in which the position or speed of each of the drive shafts J1 to J6 of the robot R, which is necessary for performing the operation according to the work program, is calculated for each time, and a necessary current is applied to each of the drive shafts J1 to J6 of the robot R. Furthermore, the robot control device C receives a feedback signal of the driving torque of each of the drive shafts J1 to J6 from the robot R, and transmits the torque value of each of the drive shafts J1 to J6 to the failure prediction device 1.

The monitor M can be configured by a display device such as a liquid crystal display panel. The monitor M may be attached to the failure prediction device 1, may be attached to the robot control device C, or may be provided at a position away from the failure prediction device 1 and the robot control device C, for example, at a position visible from many places in a factory in which the robot R is disposed.

The failure prediction device 1 is, for example, a computer device including a CPU, a memory, a communication interface, and the like.

The CPU is a processor that entirely controls the failure prediction device 1. The CPU reads the system program and application program stored in the memory via a bus, and controls the whole failure prediction device 1 according to the system program and the application program. Thus, as shown in FIG. 1, the failure prediction device 1 is configured to implement the functions of an evaluation data collection unit 10, an evaluation equation derivation unit 20, a false detection determination unit 30, a prediction determination unit 40, and a display control unit 50.

The evaluation data collection unit 10 collects evaluation data of at least the drive shafts of the robot R to be worked based on the work program.

Specifically, for example, the evaluation data collection unit 10 collects, as evaluation data, the time-series torque values of the drive shafts J1 to J6 of the robot R operating in accordance with the work program from the robot control device C. That is, the evaluation data collection unit 10 stores the value of the driving torque of each of the drive shafts J1 to J6 for each time.

The evaluation equation derivation unit 20 derives a first evaluation equation and a second evaluation equation as evaluation equations for each of the drive shafts J1 to J6 that approximate the temporal change of the torque value (evaluation data) of each of the drive shafts J1 to J6 of the robot R that are operating in accordance with the work program most recently (within a certain time range until now) among the torque values (evaluation data) collected by the evaluation data collection unit 10.

Specifically, the evaluation equation derivation unit 20 performs, for example, a normalization processing process of converting the most recent torque values Tq(t) (evaluation data) of the respective drive shafts J1 to J6 of the robot R into values between 0 and 1 using equation (1).

$$< Tq ( t ) >= Tq ( t ) - {Tq}_{min} / ( T {q}_{max} - T {q}_{min} ) \times ( 1 - 0 ) \qquad ( 1 )$$

Here, Tq(t) represents the torque value at the most recent time t. <Tq(t)> represents a value between 0 and 1 in which Tq(t) is normalized. Tqₘₐₓ represents the most recent maximum torque value, and becomes “1” by the normalization processing of equation (1). Tqₘᵢₙ represents the most recent minimum torque value, and becomes “0” by the normalization processing of equation (1).

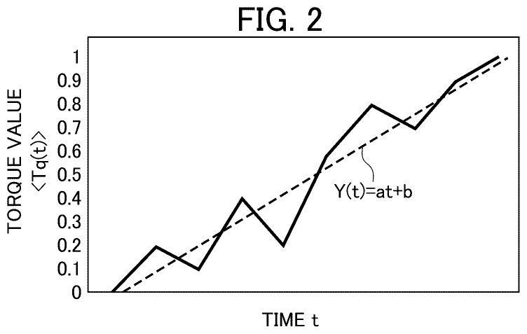

As shown in FIG. 2, the evaluation equation derivation unit 20 derives a linear function Y(t)=at+b (a, b are constants) as a first evaluation equation indicated by a broken line obtained by linear regression of the temporal change of the normalized torque value <Tq(t)> indicated by a solid line. That is, the evaluation equation derivation unit 20 calculates the values of the constants a and b of the equation representing the torque value <Tq(t)> obtained by normalizing the evaluation equation Y(t)=at+b by linear regression.

FIG. 2 shows, for example, the most recent 10 torque values Tq(t) as evaluation data.

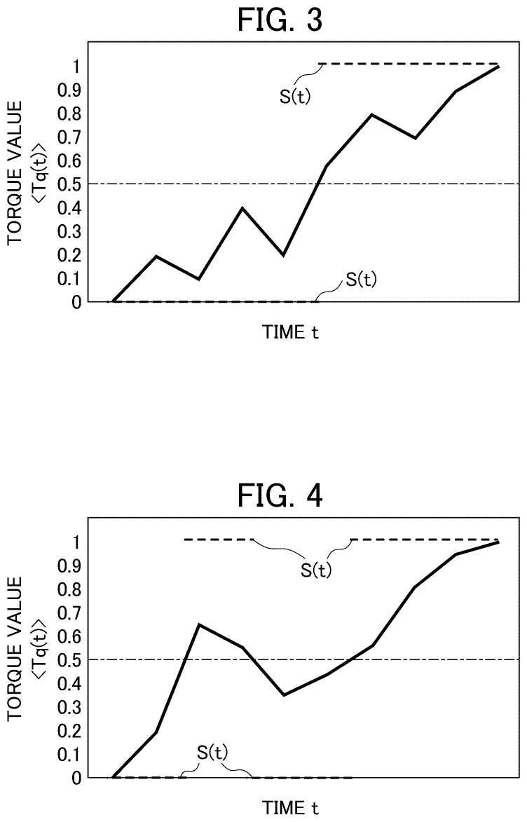

Furthermore, for example, as shown in FIG. 3, the evaluation equation derivation unit 20 derives the second evaluation equation (hereinafter, also referred to as “false detection evaluation equation”) S(t) (indicated by a broken line) obtained by binarizing the temporal change of the normalized torque value <Tq(t)>. With regard to the second evaluation equation, in the binarization processing, evaluation data in which the torque value <Tq(t)> is equal to or less than an average value of the maximum value “1” and the minimum value “0” (i.e., “0.5” indicated by the one-dot chain line) is set to “0”, and evaluation data in which the torque value <Tq(t)> exceeds the average value of the maximum value “1” and the minimum value “0” (i.e., “0.5” indicated by the one-dot chain line) is set to “1”.

FIG. 4 shows an example of the false detection evaluation equation S(t) of the torque value when the temporal change of the torque value <Tq(t)> is different from that of FIG. 3.

As shown in FIG. 4, when the evaluation data varies around “0.5”, the false detection evaluation equation S(t) varies to “0” or “1” according to the variation.

The false detection determination unit 30 determines whether the evaluation data of each drive shaft is an evaluation data value due to a change in the work program or the like or an evaluation data value due to a factor causing a failure of the robot R, based on, for example, the first evaluation equation and the second evaluation equation (false detection evaluation equation) as evaluation equations for evaluating the evaluation data using torque values (evaluation data) of each of the drive shafts J1 to J6 derived by the evaluation equation derivation unit 20, and the evaluation data.

The false detection determination unit 30 calculates a threshold r₁ as a first threshold based on the difference between the value calculated by the first evaluation equation Y(t)=at+b, which was derived by the evaluation equation derivation unit 20 and the evaluation data of the normalized torque value <Tq(t)>, and a threshold r₂ as a second threshold based on the difference between the value calculated by the second evaluation equation (false detection evaluation equation) S(t) and the evaluation data of the normalized torque value <Tq(t)>, using equations (2) and (3).

$${r}_{1} = sqrt ( \sum {( < Tq ( t ) > - Y ( t ) )}^{2} ) \qquad ( 2 )$$

$${r}_{2} = sqrt ( \sum {( < Tq ( t ) > - S ( t ) )}^{2} ) \qquad ( 3 )$$

When the threshold r₁≥the threshold r₂, the false detection determination unit 30 determines that the evaluation data is a normal value including a case where the evaluation data becomes an evaluation data value due to a factor other than a failure of the robot R. Hereinafter, to express this determination concisely, it is also referred to as determining the evaluation data as false detection.

Conversely, when comparing the calculated threshold r₁ with the threshold r₂, and the threshold r₁<the threshold r₂, the false detection determination unit 30 determines that it is an evaluation data value due to a factor causing a failure of the robot R. Hereinafter, to express this determination concisely, it is also referred to as determining the evaluation data as non-false detection.

It has been confirmed from the robot production operation data accumulated in the past that it is possible to determine whether the evaluation data value is normal, including an evaluation data value due to a factor other than robot failure or an evaluation data value due to a factor causing robot failure, by using the threshold r₁ and the threshold r₂.

For example, when the false detection determination unit 30 determines the evaluation data as non-false detection, the prediction determination unit 40 determines whether the slope a of the first evaluation equation Y(t) derived by the evaluation equation derivation unit 20, for the drive shaft of the robot R determined as non-false detection, exceeds a preset threshold. When the slope a of the first evaluation equation Y(t) exceeds the preset threshold, the prediction determination unit 40 determines that a failure of the drive shaft is predicted.

When the false detection determination unit 30 determines the evaluation data as false detection, the prediction determination unit 40 skips the prediction of a failure of the drive shaft.

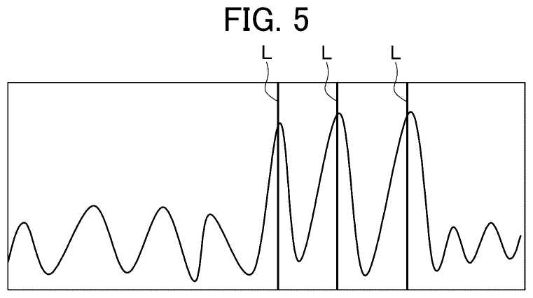

As shown in FIG. 5, the display control unit 50 displays the most recent torque values (evaluation data) in a graph on the screen of the monitor M, and when the prediction determination unit 40 determines that the failure of the drive shafts J1 to J6 is predicted, the display control unit 50 displays the result using a marker or the like. This makes it possible to notify the user that the failure is predicted. As a method of displaying the marker indicating that the failure is predicted, for example, as shown in FIG. 5, a straight line L indicating the time of the last torque value when the prediction determination unit 40 determines that the failure of the drive shafts J1 to J6 is predicted may be displayed on the graph of the torque value. The straight line L is preferably displayed in a color (for example, red color or the like) which is more conspicuous than a line that plots the torque value.

When the false detection determination unit 30 determines the evaluation data as false detection, the display control unit 50 may cause the monitor M to preferentially display information indicating that the evaluation data is false detection.

### Failure Prediction Processing of Failure Prediction Device 1

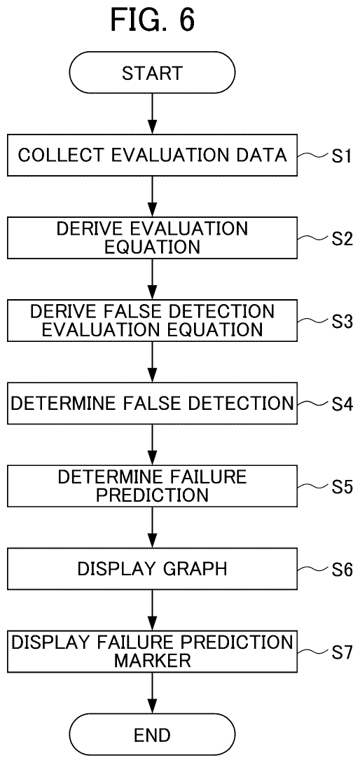

Next, the flow of the failure prediction processing of the failure prediction device 1 will be described with reference to FIG. 6.

FIG. 6 is a flowchart illustrating the failure prediction processing of the failure prediction device 1. The flow shown here is repeatedly executed while the robot R is operating based on the work program.

In Step S1, the evaluation data collection unit 10 collects, as evaluation data, the time-series torque values of the drive shafts J1 to J6 of the robot R operating in accordance with the work program from the robot control device C.

In Step S2, the evaluation equation derivation unit 20 performs a normalization processing process of the most recent torque values Tq(t) of the drive shafts J1 to J6 among the torque values collected in Step S1 and linear regression of the temporal change of the normalized torque value <Tq(t)> to derive the evaluation equation Y(t) as the first evaluation equation for each of the drive shafts J1 to J6.

In Step S3, the evaluation equation derivation unit 20 derives the false detection evaluation equation S(t) as the second evaluation equation by binarizing the temporal change of the torque value <Tq(t)> normalized in Step S2.

In Step S4, the false detection determination unit 30 compares the threshold r₁ based on the difference between the first evaluation equation Y(t) derived in Step S2 and the evaluation data of the normalized torque value <Tq(t)> with the threshold r₂ based on the difference between the false detection evaluation equation S(t) as the second evaluation equation and the evaluation data of the normalized torque value <Tq(t)>, and determines whether the evaluation data of each of the drive shafts J1 to J6 is false detection.

In Step S5, the prediction determination unit 40 determines whether the slope a of the first evaluation equation Y(t) derived in Step S2 has exceeded a preset threshold for the drive shaft of the robot R for which evaluation data is determined as non-false detection in Step S4, that is, whether a failure of the drive shaft is predicted.

In Step S6, the display control unit 50 displays the most recent torque values in a graph on the screen of the monitor M.

In Step S7, when it is determined in Step S5 that the failure of the drive shafts J1 to J6 is predicted, the display control unit 50 displays the time of the end point of the torque value on which the determination is based, with the straight line L on the graph.

As described above, the failure prediction device 1 according to one embodiment normalizes the torque values Tq(t) of the drive shafts J1 to J6 in the operation of the robot R according to the work program currently being executed, derives the first evaluation equation Y(t) indicating the change of the normalized torque value <Tq(t)>, and derives the false detection evaluation equation S(t) as the second evaluation equation. The failure prediction device 1 compares the threshold r₁ based on the difference between the first evaluation equation Y(t) and the evaluation data of the normalized torque value <Tq(t)> with a threshold r₂ based on the difference between the false detection evaluation equation S(t) as the second evaluation equation and the evaluation data of the normalized torque value <Tq(t)>, thereby determining whether the evaluation data of each of the drive shafts J1 to J6 is false detection, and determines whether a failure is predicted for the drive shaft of the robot R for which evaluation data is determined as non-false detection.

Thus, even if the operation pattern of the robot R changes, the failure prediction device 1 can accurately predict whether the evaluation data value due to the change of the operation pattern is an evaluation data value due to a factor causing a failure of the robot R without falsely detecting the evaluation data value as a failure.

Although one embodiment has been described above, the failure prediction device 1 is not limited to the above embodiment, and includes modifications, improvements, and the like within a range in which the object can be achieved.

### Modification 1

In one embodiment, the evaluation equation derivation unit 20 derives the false detection evaluation equation S(t) as the second evaluation equation by binarizing the temporal change of the normalized torque value <Tq(t)>, but the present invention is not limited thereto. For example, the evaluation equation derivation unit 20 may derive the false detection evaluation equation S(t) as the second evaluation equation of the step function by approximating the temporal change of the normalized torque value <Tq(t)>.

### Modification 2

Further, for example, in the above embodiment, the evaluation equation derivation unit 20 derives the first evaluation equation Y(t) by linear regression of the temporal change of the normalized torque value <Tq(t)>, but the present invention is not limited thereto. For example, the evaluation equation derivation unit 20 may derive the first evaluation equation Y(t) by linear regression of the temporal change of the torque value Tq(t).

### Modification 3

Further, for example, in the above embodiment, the evaluation equation derivation unit 20 is configured as a functional unit different from the false detection determination unit 30, but may be included in the false detection determination unit 30.

### Modification 4

Further, for example, in the above-described embodiment, the false detection determination unit 30 determines whether the evaluation data is false detection, and the prediction determination unit 40 determines whether the drive shaft of the robot R for which evaluation data is determined as non-false detection fails, but the present invention is not limited thereto. For example, the prediction determination unit 40 may predict a failure of the drive shaft based on the evaluation data, and the false detection determination unit 30 may determine whether the evaluation data is false detection after the prediction determination unit 40 predicts the failure of the drive shaft.

Each function included in the failure prediction device 1 in one embodiment can be implemented by hardware, software, or a combination thereof. Here, “implemented by software” means implementation by a computer reading and executing a program.

The program may be stored and provided to a computer using various types of non-transitory computer readable media. The non-transitory computer readable media include various types of tangible storage media. Examples of the non-transitory computer readable media include magnetic recording media (e.g., flexible disks, magnetic tapes, hard disk drives), magneto-optical recording media (e.g., magneto-optical disks), CD-ROMs (read only memories), CD-Rs, CD-R/Ws, and semiconductor memories (e.g., mask ROMs, PROMs (programmable ROMs), EPROMs (erasable PROMs), flash ROMs, and RAMs). The program may also be provided to a computer by various types of transitory computer readable media. Examples of the transitory computer readable media include electrical signals, optical signals, and electromagnetic waves. The transitory computer readable media can provide the program to the computer via a wired communication path, such as an electric wire or an optical fiber, or a wireless communication path.

Note that the steps of describing the program recorded in the recording medium include not only the processing performed in time series along the order but also the processing performed in parallel or individually without necessarily being processed in time series.

In other words, the failure prediction device of the present disclosure can take various embodiments having the following configurations.

(1) A failure prediction device 1 of the present disclosure includes an evaluation data collection unit 10 configured to collect evaluation data of at least a drive shaft of a robot R working based on a work program, and a false detection determination unit 30 configured to derive an evaluation equation for evaluating the evaluation data using the evaluation data and to determine whether the evaluation data is an evaluation data value due to a factor other than a failure of the robot R or an evaluation data value due to a factor causing a failure of the robot R, based on the evaluation equation and the evaluation data.

According to the failure prediction device 1, even if the operation pattern of the robot R changes, it is possible to accurately predict whether the evaluation data value detected due to the change of the operation pattern is an evaluation data value due to a factor causing a failure of the robot R without falsely detecting the evaluation data value as a failure.

(2) In the failure prediction device 1 according to (1), the false detection determination unit 30 may derive the evaluation equation for each of the evaluation data.

(3) The failure prediction device 1 according to (1) or (2) may include a prediction determination unit 40 configured to predict a failure of the drive shaft based on the evaluation data when the false detection determination unit 30 determines that the evaluation data is the evaluation data value due to the factor causing the failure of the robot R.

(4) In the failure prediction device 1 according to any one of (1) to (3), the false detection determination unit 30 may derive a threshold based on a difference between the evaluation data and a value of the evaluation equation, and may determine, based on the evaluation data and the threshold, whether the evaluation data is the evaluation data value due to the factor other than the failure of the robot R or the evaluation data value due to the factor causing the failure of the robot R.

(5) In the failure prediction device 1 according to (4), the evaluation equation may include a first evaluation equation obtained by linear regression of the evaluation data, and a second evaluation equation obtained by performing step function or binarization processing on the evaluation data. The threshold may be derived based on a difference between the evaluation data and a value of the first evaluation equation or a value of the second evaluation equation.

(6) In the failure prediction device 1 according to (3), the prediction determination unit 40 may skip the prediction of the failure of the drive shaft when the false detection determination unit 30 determines that the evaluation data is the evaluation data value due to the factor other than the failure of the robot R.

(7) The failure prediction device 1 according to (1) may include a prediction determination unit 40 configured to predict a failure of the drive shaft based on the evaluation data. The false detection determination unit 30 may determine whether the evaluation data is the evaluation data value due to the factor other than the failure of the robot R or the evaluation data value due to the factor causing the failure of the robot R after the prediction determination unit 40 predicts the failure of the drive shaft.

(8) In the failure prediction device 1 according to (5), the threshold may include a first threshold derived based on the difference between the evaluation data and the value of the first evaluation equation, and a second threshold derived based on the difference between the evaluation data and the value of the second evaluation equation. The false detection determination unit 30 may determine that the evaluation data is the evaluation data value due to the factor other than the failure of the robot R when the first threshold is equal to or greater than the second threshold, and may determine that the evaluation data is the evaluation data value due to the factor causing the failure of the robot R when the first threshold is smaller than the second threshold.

(9) A failure prediction device 1 of the present disclosure includes an evaluation data collection unit 10 configured to collect evaluation data of a robot R working based on a work program, a false detection determination unit 30 configured to determine whether the evaluation data is an evaluation data value due to a factor other than a failure of the robot or an evaluation data value due to a factor causing a failure of the robot R, and a display control unit 50 configured to cause a monitor M to display at least one of a prediction result of a failure of the robot R predicted based on the evaluation data or information indicating a determination result of the false detection determination unit 30. When the evaluation data value due to the factor other than the failure of the robot R is determined, the display control unit 50 causes the monitor M to preferentially display information indicating the evaluation data value due to the factor other than the failure of the robot R.

This failure prediction device 1 can achieve the same effect as that of (1).

### EXPLANATION OF REFERENCE NUMERALS

1 failure prediction device
10 evaluation data collection unit
20 evaluation equation derivation unit
30 false detection determination unit
40 prediction determination unit
50 display control unit
R robot
J1, J2, J3, J4, J5, J6 drive shaft

1. A failure prediction device comprising:
an evaluation data collection unit configured to collect evaluation data of at least a drive shaft of a robot working based on a work program; and
a false detection determination unit configured to derive an evaluation equation for evaluating the evaluation data using the evaluation data and to determine whether the evaluation data is an evaluation data value due to a factor other than a failure of the robot or an evaluation data value due to a factor causing a failure of the robot, based on the evaluation equation and the evaluation data.

2. The failure prediction device according to claim 1, wherein the false detection determination unit derives the evaluation equation for each of the evaluation data.

3. The failure prediction device according to claim 1, comprising a prediction determination unit configured to predict a failure of the drive shaft based on the evaluation data when the false detection determination unit determines that the evaluation data is the evaluation data value due to the factor causing the failure of the robot.

4. The failure prediction device according to claim 1,
wherein the false detection determination unit derives a threshold based on a difference between the evaluation data and a value of the evaluation equation, and
determines, based on the evaluation data and the threshold, whether the evaluation data is the evaluation data value due to the factor other than the failure of the robot or the evaluation data value due to the factor causing the failure of the robot.

5. The failure prediction device according to claim 4,
wherein the evaluation equation includes a first evaluation equation obtained by linear regression of the evaluation data, and a second evaluation equation obtained by performing step function or binarization processing on the evaluation data, and
wherein the threshold is derived based on a difference between the evaluation data and a value of the first evaluation equation or a value of the second evaluation equation.

6. The failure prediction device according to claim 3, wherein the prediction determination unit skips the prediction of the failure of the drive shaft when the false detection determination unit determines that the evaluation data is the evaluation data value due to the factor other than the failure of the robot.

7. The failure prediction device according to claim 1,
wherein the failure prediction device comprises a prediction determination unit configured to predict a failure of the drive shaft based on the evaluation data, and
wherein the false detection determination unit determines whether the evaluation data is the evaluation data value due to the factor other than the failure of the robot or the evaluation data value due to the factor causing the failure of the robot after the prediction determination unit predicts the failure of the drive shaft.

8. The failure prediction device according to claim 5,
wherein the threshold includes a first threshold derived based on the difference between the evaluation data and the value of the first evaluation equation, and a second threshold derived based on the difference between the evaluation data and the value of the second evaluation equation, and
wherein the false detection determination unit determines the evaluation data value due to the factor other than the failure of the robot when the first threshold is equal to or greater than the second threshold, and determines the evaluation data value due to the factor causing the failure of the robot when the first threshold is smaller than the second threshold.

9. A failure prediction device comprising:
an evaluation data collection unit configured to collect evaluation data of a robot working based on a work program;
a false detection determination unit configured to determine whether the evaluation data is an evaluation data value due to a factor other than a failure of the robot or an evaluation data value due to a factor causing a failure of the robot; and
a display control unit configured to cause a display unit to display at least one of a prediction result of a failure of the robot predicted based on the evaluation data or information indicating a determination result of the false detection determination unit,
wherein, when the evaluation data value due to the factor other than the failure of the robot is determined, the display control unit causes the display unit to preferentially display information indicating the evaluation data value due to the factor other than the failure of the robot.
